(19) United States
(12) Patent Application Publication
(10) Pub. No.: US 2024/0387852 A1
(43) Pub. Date: Nov. 21, 2024

(54) BATTERY CELL MANUFACTURING APPARATUS AND BATTERY CELL MANUFACTURING METHOD USING THE SAME

(71) Applicant: SK ON CO., LTD., Seoul (KR)

(72) Inventors: Jae Min RYU, Daejeon (KR); Wook Kyoung KIM, Daejeon (KR); Sang Jun PARK, Daejeon (KR); Ji Eun AHN, Daejeon (KR); Kang San KIM, Daejeon (KR)

(21) Appl. No.: 18/660,230

(22) Filed: May 10, 2024

(30) Foreign Application Priority Data
May 19, 2023 (KR) 10-2023-0064940

(51) Int. Cl. H01M 10/04; H01M 50/178

(52) U.S. Cl. CPC H01M 10/0404; H01M 50/178

(57) ABSTRACT

The present disclosure relates to a battery cell manufacturing apparatus assembling a battery cell including: an electrode assembly; an exterior material accommodating the electrode assembly therein; an electrode lead electrically connected to the electrode assembly and protruding to the outside of the exterior material; and an insulating portion insulating between the exterior material and the electrode lead, comprising: a supporting portion supporting a preliminary assembly in which the electrode assembly, the electrode lead, and the insulating portion are coupled; a photographing portion photographing a photographing area including the electrode lead and the insulating portion in the preliminary assembly; a transferring portion moving the preliminary assembly to a preset target area on the exterior material; and a controlling portion controlling at least one of the photographing portion, the transferring portion.

### CROSS-REFERENCE TO RELATED PATENT APPLICATION

The present application claims priority under 35 U.S.C. § 119 (a) to Korean patent application number 10-2023-0064940 filed on May 19, 2023, in the Korean Intellectual Property Office, the entire disclosure of which is incorporated by reference herein.

### BACKGROUND OF THE INVENTION

### 1. Field

The present disclosure relates to a battery cell manufacturing apparatus. Specifically, the present disclosure relates to a battery cell manufacturing apparatus and a battery cell manufacturing method, which can improve the production efficiency of battery cells.

### 2. Description of the Related Art

A secondary battery is a battery that is made to convert electrical energy into chemical energy and store it so that it may be reused multiple times through charging and discharging. Secondary batteries are widely used across industries due to their economical and eco-friendly characteristics. In particular, among secondary batteries, lithium secondary batteries are widely used throughout industries, including portable devices that require high-density energy.

A secondary battery may be divided into a battery cell, a battery module, or a battery pack according to an assembly unit. Battery cells may be grouped to constitute a battery module. The battery modules may be grouped to constitute a battery pack.

To manufacture a battery cell, a cathode and an anode must first be manufactured. After a cathode and an anode are manufactured, an electrode assembly including the cathode and the anode may be manufactured. An electrode assembly may be accommodated and sealed in an exterior material for protecting from an external shock.

To connect an electrode assembly to the outside, an electrode lead connected to a cathode and an anode may be exposed to the outside of an exterior material through a sealing portion of the exterior material. When an electrode lead is sealed without being arranged at a correct position, battery cell performance may be degraded. In addition, when an electrode assembly is defective after sealing an exterior material, the assembled battery cell should be discarded. This may lead to production efficiency degradation and cost rise.

### SUMMARY OF THE INVENTION

One object of the present disclosure is to provide a battery cell manufacturing apparatus, which can improve production efficiency and reduce production costs by early removing defects of an electrode assembly.

In addition, another object of the present disclosure is to provide a battery cell manufacturing apparatus, which allows for manufacturing a battery cell with improved electric insulation by removing protrusion range defects of an electrode assembly.

The present disclosure can be widely applied in the field of green technology, such as electric vehicles, battery charging stations, solar power generation, and wind power generation using batteries. In addition, the present disclosure can be used in eco-friendly electric vehicles, hybrid vehicles, or the like to prevent climate change by suppressing air pollution and greenhouse gas emissions.

A battery cell manufacturing apparatus according to the present disclosure is a battery cell manufacturing apparatus assembling a battery cell including: an electrode assembly; an exterior material accommodating the electrode assembly therein; an electrode lead electrically connected to the electrode assembly and protruding to the outside of the exterior material; and an insulating portion insulating between the exterior material and the electrode lead, including: a supporting portion supporting a preliminary assembly in which the electrode assembly, the electrode lead, and the insulating portion are coupled; a photographing portion photographing a photographing area including the electrode lead and the insulating portion in the preliminary assembly; a transferring portion moving the preliminary assembly to a preset target area on the exterior material; and a controlling portion controlling at least one of the photographing portion, the transferring portion, and the supporting portion, wherein the controlling portion calculates a target length including the electrode lead and at least a part of the insulating portion along one preset direction in the photographing area and moves the preliminary assembly to the target area by controlling the supporting portion or the transferring portion based on the target length.

The target area may an area in which the exterior material and at least a part of the insulating portion overlap.

The controlling portion may determine whether the preliminary assembly is disposed in a reference area positioned above the supporting portion based on the target length.

The reference area may be positioned above the supporting portion.

When the target length is longer than or equal to a preset protrusion range or shorter than or equal to the protrusion range, the supporting portion may move to dispose the preliminary assembly in the reference area.

The transferring portion may move the preliminary assembly from the reference area to the target area.

When the target length is longer than or equal to a preset protrusion range or shorter than or equal to the protrusion range, the transferring portion may move the preliminary assembly deviated from the reference area to the target area.

The battery cell manufacturing apparatus may further include a guiding portion positioned between the photographing portion and the electrode lead to support the electrode lead.

The guiding portion may be positioned to be spaced apart from electrode lead below the electrode load.

A length of the electrode lead along a protruding direction of the electrode lead may be longer than or equal to a length from one surface of the guiding portion towards the electrode assembly to the electrode assembly.

The target length may be a length from one surface of the guiding portion to one surface of the insulating portion provided to face each other.

The target length may a length from the electrode assembly to an outermost side of the insulating portion along a protruding portion in which the electrode lead protrudes.

The transferring portion is capable of transferring the preliminary assembly along an arbitrary direction.

The target length may be calculated based on values measured multiple times at different arbitrary points.

In addition, a battery cell manufacturing method of the present disclosure is a battery cell manufacturing method assembling a battery cell including: an electrode assembly; an exterior material accommodating the electrode assembly therein; an electrode lead electrically connected to the electrode assembly and protruding to the outside of the exterior material; and an insulating portion insulating between the exterior material and the electrode lead, comprising: a step of disposing a preliminary assembly on a supporting portion capable of supporting the preliminary assembly in which the electrode assembly, the electrode lead, and the insulating portion are coupled; a step of photographing a photographing area including the electrode lead and the insulating portion in the preliminary assembly; and a transferring step of calculating a target length including the electrode lead and at least a part of the insulating portion along one preset direction in the photographing area and allowing a transferring portion to transfer the preliminary assembly to the target area based on the target length.

The transferring step may determine whether the preliminary assembly is disposed in a reference area based on the target length.

Whether the preliminary assembly is disposed may be determined by comparing the target length and a preset protrusion range.

The target length may be a length from one surface of the guiding portion to one surface of the insulating portion positioned between the electrode lead and the photographing portion to support the electrode lead.

The transferring step may include a supporting portion adjustment step of allowing the supporting portion to move the preliminary assembly to the reference area and a positioning step of allowing the transferring portion to move the preliminary assembly from the reference area to the target area.

In the supporting portion adjustment step, the supporting portion may move in parallel with a direction in which the electrode lead protrudes.

In the transferring step, the transferring portion may transfer a preliminary assembly deviated from the reference area to the target area.

The present disclosure may provide battery cell manufacturing apparatus, which can improve production efficiency and reduce production costs by early removing defects of an electrode assembly.

In addition, the present disclosure may provide a battery cell manufacturing apparatus, which allows for manufacturing a battery cell with improved electric insulation by removing protrusion range defects of an electrode assembly.

### BRIEF DESCRIPTION OF THE DRAWINGS

FIG. 1 shows a battery cell according to the present disclosure.

FIG. 2 shows an exploded view of a battery cell according to the present disclosure.

FIG. 3 shows a preliminary assembly and an exterior material according to the present disclosure.

FIG. 4A and FIG. 4B show an electrode assembly being accommodated in an exterior material according to the present disclosure.

FIG. 5 shows a battery cell manufacturing apparatus according to the present disclosure.

FIG. 6A and FIG. 6B show a reference area and a target area according to the present disclosure.

FIG. 7 shows a photographing area of a battery cell according to the present disclosure.

FIG. 8 shows a battery cell manufacturing method according to the present disclosure.

FIG. 9 shows an example of a transferring step according to the present disclosure.

### DETAILED DESCRIPTION

Hereinafter, the present disclosure will be described in detail with reference to the attached drawings. The configuration or control method of the device described below is only for explaining the embodiments of the present disclosure and is not intended to limit the scope of the present disclosure, and the same reference numerals used throughout the specification indicate the same components.

Specific terms used in the present specification are merely for convenience of explanation and are not used to limit the illustrated embodiments.

For example, expressions such as “same” and “is the same” not only indicate a strictly identical state, but also indicate a state in which there is a difference in tolerance or the degree to which the same function is obtained.

For example, expressions representing relative or absolute arrangement such as “in a certain direction,” “along a certain direction,” “side by side,” “perpendicularly,” “at the center,” “concentric,” or “coaxial,” not only strictly represent the arrangement, but also represent the state of relative displacement with a tolerance, or an angle or distance at which the same function is obtained.

To explain the present disclosure, it will be described below based on a spatial orthogonal coordinate system with X, Y, and Z axes orthogonal to each other. Each axis direction (X-axis direction, Y-axis direction, Z-axis direction) refers to both directions in which each axis extends.

The X-direction, Y-direction, and Z-direction mentioned below are for explanation so that the present disclosure may be clearly understood, and of course, the directions may be defined differently depending on where the reference is placed.

The use of terms such as ‘first, second, and third’ in front of the components mentioned below is only to avoid confusion about the components to which they are referred and is irrelevant to the order, importance, or master-slave relationship between the components, etc. For example, an invention that includes only a second component without a first component may also be implemented.

As used in the present specification, singular expressions include plural expressions unless the context clearly dictates otherwise.

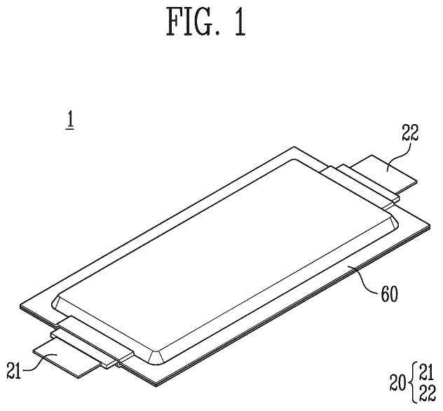

FIG. 1 shows a battery cell according to the present disclosure.

A battery cell described in the present specification refers to a secondary battery that may be repeatedly used by charging and discharging electrical energy. For example, a battery cell may be a lithium secondary battery, but it is not limited thereto.

Battery cells may be classified into a pouch-type secondary battery, a prismatic secondary battery, or a cylindrical secondary battery depending on the shape. In the present specification, a pouch-type secondary battery is shown as an example for convenience of explanation, but the present invention is not limited thereto.

Main components of a battery cell is a cathode, an anode, a separator, and an electrolyte, and a battery cell may be made by putting the main components into an exterior material (case or pouch, 60).

A cathode and an anode may include a current collector. A cathode may include a cathode current collector, and an anode may include an anode current collector. A current collector may include a known conductive material to an extent that it does not cause a chemical reaction within a lithium secondary battery.

For example, a current collector may include any one of stainless steel, nickel (Ni), aluminum (Al), titanium (Ti), copper (Cu), and alloys thereof, and may be provided in various forms such as a film, a sheet, a foil, and the like.

A cathode and an anode may include an active material. A cathode may include a cathode active material, and an anode may include an anode active material. A cathode active material may be a material which lithium (Li) ions may be inserted into and extracted from. An anode active material may be a material which lithium ions may be adsorbed into and extracted from.

For example, a cathode active material may be a lithium metal oxide, and an anode active material may be any one of a carbon-based material such as crystalline carbon, amorphous carbon, carbon composite, and carbon fiber, a lithium alloy, silicon (Si), and tin (Sn).

In addition, a cathode and an anode may each further include a binder and a conductive material to improve mechanical stability and electrical conductivity.

A separator may be formed to prevent an electrical short circuit between a cathode and an anode and to generate a flow of ions. The type of a separator is not particularly limited, but may include a porous polymer film. For example, a separator may include a porous polymer film or a porous nonwoven fabric. A separator may include polyethylene or polypropylene.

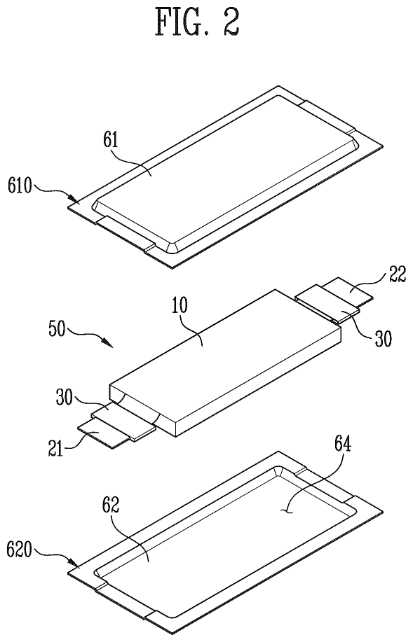

A cathode, an anode, and a separator may be stacked to form an electrode assembly (10 in FIG. 2). A separator may be interposed between a cathode and an anode to prevent contact between the cathode and the anode.

Electrode assemblies may be classified into a stacking type, a folding type, a stack-folding type, and a winding type.

An exterior material 60 may accommodate an electrode assembly 10 and an electrolyte solution therein. An exterior material 60 may be provided with an external insulating layer made of a polymer material, an internal adhesive layer, and a metal layer interposed between the external insulating layer and the internal adhesive layer.

An exterior material 60 may include a material with high mechanical rigidity to protect a battery cell from external shock. For example, an exterior material 60 may include an aluminum layer.

A battery cell 1 may further include an electrode lead 20 protruding out of an exterior material 60 for electrical connection to the outside. An electrode lead 20 may each be connected to a cathode and an anode of a battery cell. An electrode lead 20 may include a cathode lead 21 connected to a cathode and an anode lead 22 connected to an anode.

Consequently, referring to FIG. 1, a battery cell includes an electrode assembly 10, an exterior material 60 accommodating the electrode assembly 10 therein, and an electrode lead 20 electrically connected to the electrode assembly 10 and protruding to the outside of the exterior material 60.

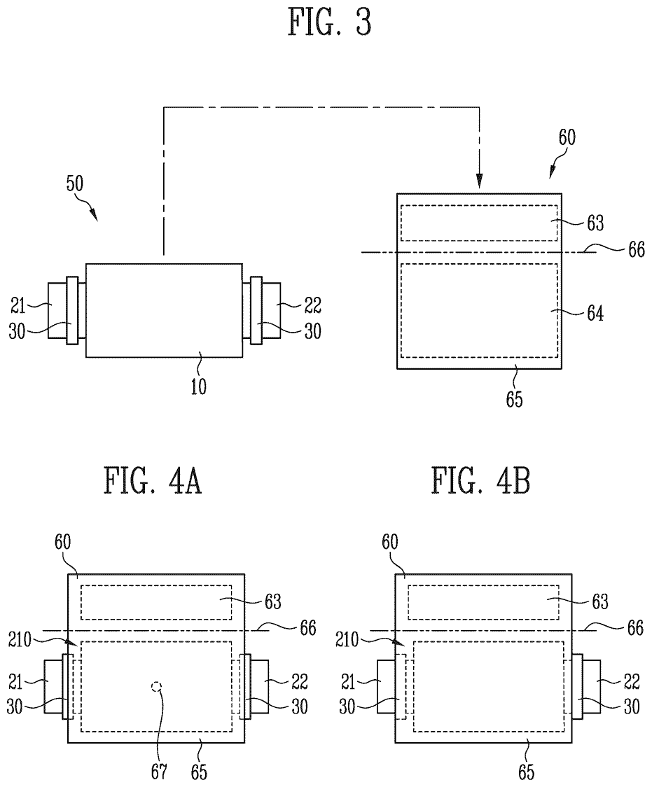

FIG. 2 shows an exploded view of a battery cell according to the present disclosure, and FIG. 3 shows a preliminary assembly and an exterior material according to the present disclosure.

Referring to FIG. 2, a battery cell further includes an insulating portion 30. An insulating portion 30 may electrically insulate an electrode lead 20 and an exterior material 60. An insulating portion 30 may be positioned between an exterior material 60 and an electrode lead 20 to improve a sealing force of the exterior material 60.

An insulating portion 30 may be provided outside an electrode lead 20. An insulating portion 30 may prevent contact between an electrode lead 20 and an exterior material 60. To this end, an insulating portion 30 may be provided to in a shape surrounding an electrode lead 20 along a surface on which an electrode lead 20 is in contact with an exterior material 60. An insulating portion may be referred to as a lead film or sealant.

An insulating portion 30 may include a thermally polymerizable compound. For example, when an insulating portion 30 is heated, the insulating portion 30 and an exterior material 60 may be strongly bonded through a polymerization reaction or crosslinking reaction of a thermally polymerizable compound. Through this, an insulating portion 30 may improve a sealing force of an exterior material 60 and an electrode lead 20.

An insulating portion 30 may include any one material selected from the group consisting of polyethylene, polypropylene, polycarbonate, polyethylene terephthalate, polyvinyl chloride, an acrylic polymer, polyacrylonitrile, polyimide, polyamide, cellulose, aramid, nylon, polyester, polyparaphenylene benzobisoxazole, polyarylide, Teflon, and glass fiber.

An insulating portion 30 may have a single film structure or a composite film structure consisting of two or more materials. An insulating portion 30 may have a double-layer structure.

Meanwhile, an electrode assembly 10, an electrode lead 20, and an insulating portion 30 may be combined to form a preliminary assembly 50. A preliminary assembly 50 may be formed by manufacturing an electrode assembly 10 including a cathode, an anode, and a separator, and then combining an electrode lead 20 and an insulating portion 30 with the electrode assembly 10.

After a preliminary assembly 50 moves to a preset target area 210 on an exterior material 60, the exterior material 60 may be sealed to manufacture a battery cell 1 including an electrode assembly 10 therein.

Referring to FIG. 2, an exterior material 60 may be sealed to form a cup portion 64 accommodating an electrode assembly 10 therein. An exterior material 60 may be sealed through sealing portions 610 and 620 provided at an edge.

An insulating portion 30 may be provided on the outside of an electrode lead 20 while surrounding at least a part of the electrode lead 20. When an exterior material 60 is sealed, an insulating portion 30 will be interposed between sealing portions 610 and 620. This is to block electrical connection between an electrode lead 20 and an exterior material 60. Through this, an electrode assembly 10 may be electrically connected to the outside through an electrode lead 20.

Referring to FIG. 2, an exterior material 60 may include an upper case 61 and a lower case 62. An upper case 61 or a lower case 62 may include a cup portion 64 for accommodating an electrode assembly 10. A cup portion 64 may be formed by recessing one side surface of an upper case 61 or of a lower case 62 to a certain depth.

Referring to FIG. 3, an upper case 61 of an exterior material 60 may be formed integrally with a lower case 62. For example, an upper case 61 may be formed integrally with a lower case 62 and may be folded. An exterior material 60 may be folded so that an upper sealing portion 610 provided at an edge of an upper case 61 may contact with a lower sealing portion 620 provided at an edge of a lower case 62.

An exterior material 60 may further include a gas-accommodating portion 63. After an electrode assembly 10 is inserted into an exterior material 60, the electrode assembly 10 may be charged and discharged. A gas generated in this process may move a gas-accommodating portion 63. A gas-accommodating portion 63 may be removed along a cutting line 66, and a gas inside an exterior material may be removed, thereby improving the stability of a battery cell.

In addition, referring to FIG. 3, an electrode assembly 10 may be inserted into an exterior material 60. The position where an electrode assembly 10 is inserted may affect the performance of a battery cell 1. When an electrode assembly 10 is inserted to an incorrect position, an exterior material 60 may not be accurately sealed. As a result, an electrode lead 20 may contact with an exterior material 60 so that the exterior material 60 may be electrically connected to an electrode assembly 10.

Therefore, an electrode assembly 10 needs to be inserted to a correct position of an exterior material 60. In the present disclosure, an imaging area 310 including an electrode lead 20 and an insulating portion 30 is photographed so that an electrode assembly 10 may be inserted into a target area 210 of an exterior material 60 based on the photograph.

FIG. 4A and FIG. 4B show an electrode assembly 10 being accommodated in an exterior material 60 according to the present disclosure.

Referring to FIG. 4A and FIG. 4B, as described above, an exterior material 60 may be integrally formed so that an upper case 61 and a lower case 62 may be folded based on a folding line 65, and the folding line 65 may be provided between an upper case 61 and a lower case 62. Through this, an upper case 61 and a lower case 62 may be folded to move toward each other to accommodate an electrode assembly therein.

In the present specification, a direction along a folding line of an exterior material 60 is defined as a length direction of the exterior material 60. In addition, one direction perpendicular to a longitudinal direction of an exterior material 60 is defined as a height direction of the exterior material 60.

Consequently, an exterior material 60 will be provided with a cup portion 64 at the bottom along a height direction and a gas-accommodating portion 63 at the top.

An exterior material 60 may include a preset target area 210. A target area 210 refers to an area in which an electrode assembly 10 is placed inside an exterior material 60. A target area 210 may be an area in which an electrode assembly 10 is arranged so that an exterior material 60 and at least a part of an insulating portion 30 overlap along a protruding direction of an electrode lead 20. In other words, when an electrode assembly 10 is placed in a target area 210, an exterior material 60 and at least a part of an insulating portion 30 may overlap.

A target area 210 may be a virtual area provided on an exterior material 60. In other words, a target area 210 may not be marked on an actual exterior material, but may be an area that is set and recognized virtually. In addition, a target area 210 may be a virtual area created by connecting points spaced apart by a preset standard from a reference position 67 on an exterior material 60.

For example, a target area 210 may be a cup portion 64 of an exterior material.

Referring to FIG. 4A, when an electrode assembly 10 is positioned in a target area 210, insulating portions 30 provided on a cathode lead 21 and an negative electrode lead 22 may protrude to the outside by a same length.

Referring to FIG. 4B, when an electrode assembly 10 is deviated from a target area 210, an insulating portion 30 may be accommodated inside an exterior material 60. This may cause battery cell failure.

The present disclosure includes a supporting portion 100 supporting a preliminary assembly 50, a photographing portion 200, a transferring portion 300, and a controlling portion 500.

A supporting portion 100 may support a preliminary assembly 50 by contacting with one surface of the preliminary assembly 50. A supporting portion 100 may be a plate of a flat shape. Through this, a preliminary assembly 50 may be supported without damage.

A supporting portion 100 may include a protruding portion 112 on one surface contacting with a preliminary assembly 50 and extending upward. Even when a supporting portion moves due to a protruding portion 112, a preliminary assembly 50 may not fall from the supporting portion.

A supporting portion 100 is movable. A supporting portion 100 may move to change the position of a preliminary assembly 50. A supporting portion 100 may move to move a preliminary assembly 50 to a reference area 110.

When a preliminary assembly 50 is positioned on a supporting portion 100, a part of an electrode lead 20 may protrude to the outside of a supporting portion 100. Through this, a photographing portion 200 may easily photograph an electrode lead 20.

When an electrode assembly 10 protrudes to the outside of a supporting portion 100, one end of an electrode lead 20 may be directed downward by gravity. In order to prevent damage to an electrode lead 20, the present disclosure may further include a guiding portion 400.

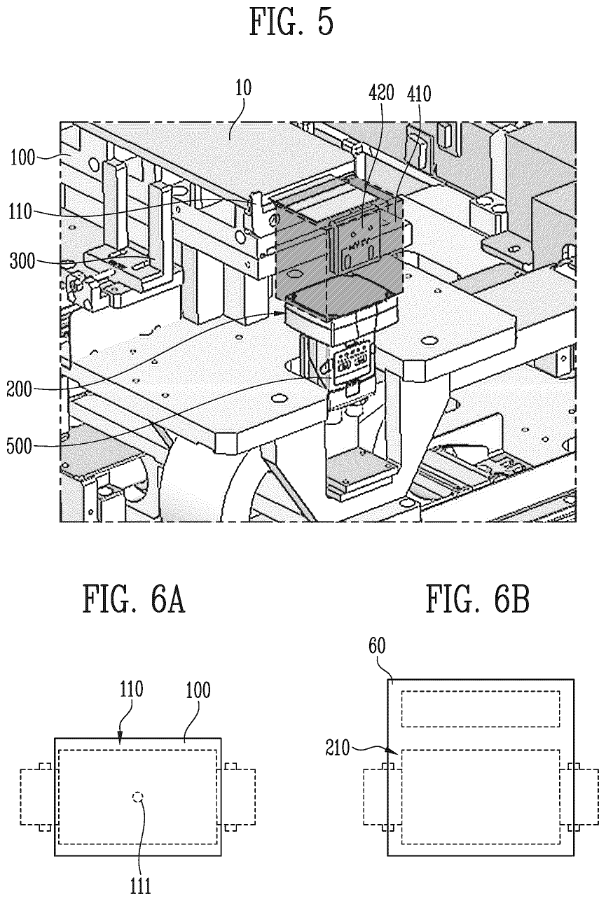

FIG. 5 shows a battery cell manufacturing apparatus according to the present disclosure.

A guiding portion 400 may support an electrode lead 20. Referring to FIG. 5, a guiding portion 400 may be formed to be spaced apart from an electrode lead 20 by a certain distance. A guiding portion 400 may be positioned below an electrode lead 20. When one end of an electrode lead 20 is directed downward, it may be supported by a guiding portion 400 to prevent sudden bending of the electrode lead 20.

A guiding portion 400 may include an extending guide 410 and a supporting guide 420. An extending guide 410 may be formed to extend along a direction in which an electrode lead 20 protrudes from a supporting portion 100. A supporting guide 420 may be formed to extend from one end of an extension guide toward a lower portion of an electrode lead 20.

Through this, when a supporting portion 100 moves, a guiding portion 400 may move together, thereby preventing damage to an electrode lead that occurs during movement.

In another embodiment, a guiding portion 400 may be provided separately from a supporting portion 100.

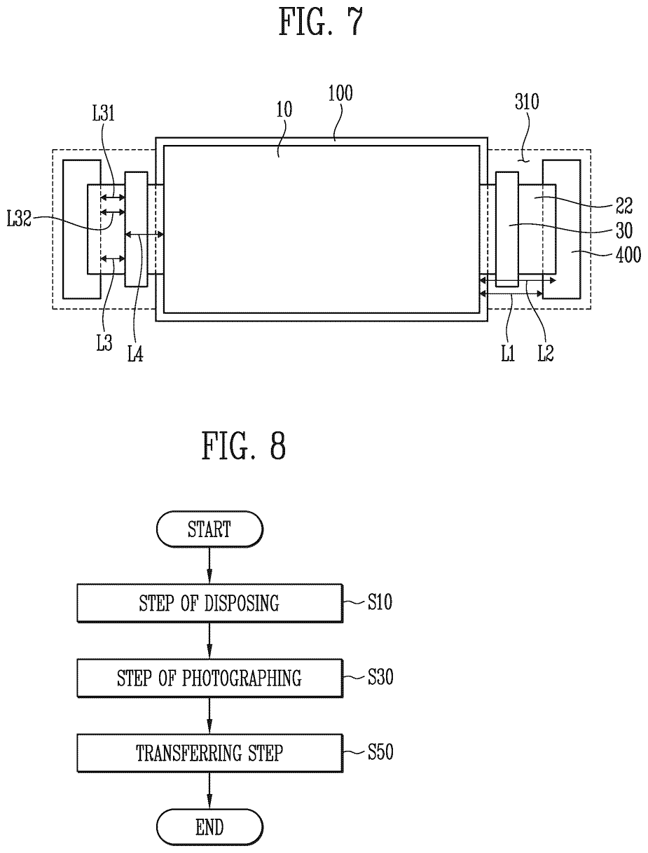

A length of an electrode lead 20 (L2 in FIG. 7) along a protruding direction of an electrode lead 20 may be longer than or equal to a length from one side surface of a guiding portion 400 facing an electrode assembly 10 to the electrode assembly 10 (L1 in FIG. 7). In other words, a part of an electrode lead 20 and a part of a guiding portion 400 may overlap along a protruding direction of an electrode lead 20.

The present disclosure includes a photographing portion 200. A photographing portion 200 may photograph a photographing area 310. A photographing area 310 may include at least a part of an electrode lead 20 in a preliminary assembly 50. In addition, a photographing area 310 may include at least a part of an insulting portion 30. A photographing portion 200 may be a vision or camera.

A photographing portion 200 may be positioned below an electrode lead 20. A guiding portion 400 may be positioned between a photographing portion 200 and an electrode lead 20. Through this, a photographing portion 200 will be able to photograph an electrode lead 20 and a guiding portion 400 overlapping.

A transferring portion 300 may transfer a preliminary assembly 50. A transferring portion 300 may transfer a preliminary assembly 50 positioned on a supporting portion 100 to another area. A transferring portion 300 may move a preliminary assembly 50 to a preset target area 210 on an exterior material 60.

A transferring portion 300 may contact with a preliminary assembly 50 to fix the preliminary assembly 50 and then transfer the same. A transferring portion 300 may move a preliminary assembly 50 in any direction. A transferring portion 300 may fix a preliminary assembly 50 and then move or rotate the same in a three-dimensional space. For example, a transferring portion 300 may be a 6-axis robot that is movable in the X-axis, Y-axis, and Z-axis directions and rotatable around each of the axes. Therefore, a transferring portion 300 may move and rotate in any directions in space. In addition, a transferring portion 300 may be a gripper.

Through this, a transferring portion 300 may transfer a preliminary assembly 50 according to a length or direction preset by a user, thereby preventing battery cell defects.

A controlling portion 500 may control at least one of a photographing portion 200, a transferring portion 300, and a supporting portion 100. A controlling portion 500 may calculate a target length including an electrode lead 20 and at least a part of an insulating portion 30 along one preset direction in a photographing area 310 and control a supporting portion 100 or a transferring portion 300 based on the target length, thereby moving a preliminary assembly 50 to a target area 210.

In one embodiment, a controlling portion 500 may move a supporting portion 100 and then move a preliminary assembly 50 based on a target length. After a preliminary assembly 50 is moved by a supporting portion 100, a transferring portion 300 may move the moved preliminary assembly 50 to a target area 210.

In another embodiment, a controlling portion 500 may reflect a correction value based on a target length to allow a transferring portion 300 to move the preliminary assembly 50 to a target area 210.

Consequently, a preliminary assembly 50 positioned on a supporting portion 100 may be disposed in a preset target area 210, thereby preventing battery cell defects.

FIG. 6A and FIG. 6B show a reference area 110 and a target area 210 according to the present disclosure.

Specifically, a controlling portion may determine whether a preliminary assembly 50 is disposed in a reference area based on a target length.

A reference area 110 refers to an area in which a preliminary assembly 50 should be placed. A reference area 110 may be positioned above a supporting portion 100. A reference area 110 may be a virtual area on a supporting portion 100. In other words, a reference area 110 may not be actually marked on a supporting portion, but may be an area that is set and recognized virtually. A reference area 110 may be a virtual area created by connecting points spaced apart by a preset standard from a reference position 111 on a supporting portion 100.

Referring to FIGS. 6A and 6B, a reference area 110 may be provided on a supporting portion 100, and a target area 210 may be provided on an exterior material 60.

In one embodiment, a transferring portion 300 may transfer a preliminary assembly 50 by a distance entered by a user. When a transferring portion 300 is controlled according to a distance entered by a user, production efficiency may be improved through repetitive work.

In other words, a transferring portion 300 may move a preliminary assembly 50 positioned in a reference area 110 to be positioned in a target area 210. Meanwhile, a preliminary assembly 50 deviated from a reference area 110 will be transferred to a position also deviated from a target area 210.

Therefore, it is necessary to position a preliminary assembly 50 deviated from a reference area 110 in the reference area 110. To this end, a supporting portion 100 may move to position a preliminary assembly 50 to a reference area 110.

Referring to FIG. 4, a preliminary assembly 50 may deviate from a target area 210 because it is not disposed at a correct position along a length direction of an exterior material 60. At this time, the length direction of the exterior material 60 will be parallel to the length direction of the preliminary assembly 50.

When looking at this from a reference area 110 on a supporting portion 100, a preliminary assembly 50 may deviate from the target area 210 because the preliminary assembly 50 is not positioned inside a reference area 110 along a length of the preliminary assembly 50. To prevent this, a supporting portion 100 may move in parallel with a direction in which an electrode lead 20 protrudes to adjust the position of the preliminary assembly 50.

In other words, a direction in which an electrode lead 20 protrudes may be in parallel with a length direction of a preliminary assembly 50. A supporting portion 100 may move in a direction in which an electrode lead 20 protrudes to position a preliminary assembly 50 in a reference area 110. A preliminary assembly 50 positioned in a reference area 110 may be transferred to a target position by a transferring portion 300.

FIG. 7 shows a photographing area 310 of a battery cell according to the present disclosure.

A controlling portion 500 may calculate a target length in a photographing area 310. Referring to FIG. 7, a target length calculated by a controlling portion 500 may be a length L3 from one side of a guiding portion 400 to one side of an insulating portion 30 provided to face each other. In other words, it may be a length from a guiding portion 400 to an insulating portion 30.

Measuring a length from a guide to an insulating portion 30 may improve the easiness and precision of measurement. Along a direction in which an electrode lead 20 protrudes, an area of an electrode lead 20 that exists farther from an electrode assembly 10 than a guiding portion 400 may be cut to adjust the length.

In addition, when an electrode lead 20 is formed to be long, it may be tilted downward by gravity and thus form an inclination so that a calculated length may not be accurate. Furthermore, an area positioned at an edge of a photographing area 310 may sometimes not be measured.

Therefore, it may be preferable to measure a length from a guiding portion 400 to an insulating portion 30.

In another embodiment, a target length may be a length L4 from an electrode assembly 10 to an outermost side of an insulating portion 30 along a direction in which an electrode lead 20 protrudes. As an area closer to an electrode assembly 10 is measured, measurement error due to an inclination of an electrode lead 20 may be minimized.

Without being limited thereto, a controlling portion 500 may measure a distance between any two different points included in a photographing area 310.

A controlling portion 500 may calculate a target length based on values measured multiple times at two different arbitrary points. For example, a controlling portion 500 may calculate an average value of values measured multiple times as a target length. Alternatively, a controlling portion 500 may calculate a target length by differentially assigning weights. This is to increase the accuracy of measuring a target length.

Values measured multiple times may be values measured by one-time photographing carried out by a photographing portion. For example, after a vision photographs a photographing area 310 once, measurement values may be calculated multiple times based on this.

However, values measured multiple times at two different points should be classified according to certain standards.

For example, referring to FIG. 7, a controlling portion 500 may measure a first distance L31, which is a distance from one surface of a guiding portion 400 to one surface of an insulating portion 30. In addition, a second distance L32 may be measured based on another position at which a distance from one surface of a guiding portion 400 to one surface of an insulating portion 3, although the position is different from the position at which the first distance is measured.

A controlling portion 500 may calculate a target length based on a first distance L31 and a second distance L32. For example, a controlling portion 500 may calculate an average distance of a first distance L31 and a second distance L32 as a target length.

A controlling portion 500 may determine whether a preliminary assembly 50 is disposed in a reference area 110 based on a target length. A controlling portion 500 may determine disposition by comparing a target length and a preset protrusion range. A preset protrusion range may be changed according to a measured target length.

For example, a protrusion range may be a normal protrusion range of an electrode lead 20. That is, both a cathode lead 21 and an anode lead 22 should exist within a protrusion range.

When a cathode lead 21 protrudes beyond a protrusion range, the cathode lead 22 will protrude below the protrusion range. Conversely, when an anode lead 22 protrudes beyond a protrusion range, a cathode lead 21 will protrude below the protrusion range.

In other words, a battery cell manufacturing apparatus of the present disclosure may photograph at least one photographing area including a cathode lead 21 or an anode lead 22 and then compare the measured target length with a protrusion range.

When a target length is longer than or equal to a preset protrusion range or shorter than or equal to the protrusion range, a supporting portion 100 may move to dispose a preliminary assembly 50 in a reference area 110. In other words, a target length being longer than or equal to a preset protrusion range or shorter than or equal to the protrusion range may mean that a preliminary assembly 50 deviates from a reference area 110.

After a supporting portion 100 disposes the preliminary assembly 50 in a reference area 110, a transferring portion 300 may move a preliminary assembly 50 from the reference area 110 to a target area 210.

After a supporting portion 100 dispose a preliminary assembly 50 in a reference area 110, a controlling portion may reconfirm whether the supporting portion 100 has disposed the preliminary assembly 50 in a reference area 110. When a supporting portion 100 may not dispose the preliminary assembly 50 in a reference area 110, a correction value may be recalculated to dispose the supporting portion 100 in the reference area 110.

In another embodiment, when a target length is longer than or equal to a preset protrusion range or shorter than or equal to the protrusion range, a transferring portion 300 may move a preliminary assembly 50 deviated from a reference area 110 to a target area 210. A transferring portion 300 may move a preliminary assembly 50 deviated from a reference area 110 to a target area 210 by reflecting a target length calculated by a controlling portion 500.

Through this, a preliminary assembly 50 does not need to be moved by a supporting portion 100 so that easiness of design may increase.

Hereinafter, a battery cell manufacturing method using a battery call manufacturing apparatus is described.

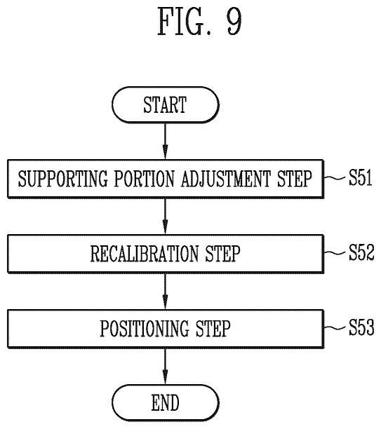

FIG. 8 shows a battery cell manufacturing method according to the present disclosure, and FIG. 9 shows an example of a transferring step according to the present disclosure.

Referring to FIG. 8, a battery cell manufacturing method according to the present disclosure includes a step S10 of disposing a preliminary assembly 50 on a supporting portion 100, a step S30 of allowing a photographing portion 310 to photograph a photographing area 310, and a transferring step S50 of calculating a target length including an electrode lead 20 and at least a part of an insulating portion 30 along one preset direction in the photographing area 310 and allowing a transferring portion 300 to transfer the preliminary assembly 50 to a target area 210 based on the target length.

First, a preliminary assembly 50 including an electrode assembly 10, an electrode lead 20, and an insulating portion 30 may be manufactured and then disposed on a supporting portion 100. A preliminary assembly 50 disposed on a supporting portion 100 may be disposed with a part of an electrode lead 20 protruding to the outside of the supporting portion 100. After a step S10 of disposing, a photographing portion 310 may photograph a photographing area 310 including an electrode lead 20 and an insulating portion 30.

After a step S30 of photographing, a target length will be calculated in a photographing area 310. A transferring step S50 of allowing a transferring portion 300 to transfer a preliminary assembly 50 to a target area 210 based on a calculated target length may be carried out.

A transferring step S50 may determine whether a preliminary assembly 50 is disposed in a reference area 110 based on a target length. By determining disposition, defective sealing of an exterior material 60 may be prevented so that production efficiency may be improved.

Whether the preliminary assembly 50 has been disposed may be determined by comparing a target length and a preset protrusion range.

A transferring step S50 may include a supporting portion adjustment step S51 and a positioning step S53. In a supporting portion adjustment step S51, when a preliminary assembly 50 deviates from a reference area 110, the preliminary assembly 50 may be moved to the reference area 110. As described above, a supporting portion 100 may move in parallel with a direction in which an electrode lead 20 protrudes to position a preliminary assembly 50 in a reference area 110.

After a supporting portion adjustment step S51, a positioning step S53 in which a transferring portion 300 moves a preliminary assembly 50 from a reference area 110 to a target area 210 may be carried out.

Referring to FIG. 9, a transferring step S50 may further include a recalibration step S52. After a supporting portion adjustment step S51, a recalibration step S52 may be carried out.

A recalibration step S52 may confirm whether a supporting portion 100 disposes the preliminary assembly 50 in a reference area 110.

In addition, in a recalibration step S52, when a supporting portion 100 does not disposed the preliminary assembly 50 in a reference area 110, a correction value may be recalculated to dispose the supporting portion 100 in the reference area 110.

In a positioning step S53, a repetitive operation in which a transferring portion 300 moves within only a preset input distance without reflecting a correction value may be performed. Since a transferring portion 300 only needs to transfer a preliminary assembly 50 disposed in a reference area 110 to a target area 210, production time will be shortened, and production efficiency will be improved.

In another embodiment, in a transferring step S50, a transferring portion 300 may transfer a preliminary assembly 50 deviated from a reference area 110 to a target area 210. Through this, a target length is calculated, and a transferring portion 300 reflects the calculated target length, so a supporting portion adjustment step S51 will not be necessary. In other words, since a transferring portion 300 may move by calculating a distance reflecting a calculated correction value, production cost may be reduced, and production efficiency May be increased depending on the design.

The present disclosure may be modified and implemented in various forms, and its scope is not limited to the embodiments described above. Therefore, when a modified embodiment includes components of the present disclosure, it should be regarded as falling within the scope of the rights of the present disclosure.

What is claimed is:

1. A battery cell manufacturing apparatus assembling a battery cell including: an electrode assembly; an exterior material accommodating the electrode assembly therein; an electrode lead electrically connected to the electrode assembly and protruding to the outside of the exterior material; and an insulating portion insulating between the exterior material and the electrode lead, comprising:
a supporting portion supporting a preliminary assembly in which the electrode assembly, the electrode lead, and the insulating portion are coupled;
a photographing portion photographing a photographing area including the electrode lead and the insulating portion in the preliminary assembly;
a transferring portion moving the preliminary assembly to a preset target area on the exterior material; and
a controlling portion controlling at least one of the photographing portion, the transferring portion, and the supporting portion,
wherein the controlling portion calculates a target length including the electrode lead and at least a part of the insulating portion along one preset direction in the photographing area and moves the preliminary assembly to the target area by controlling the supporting portion or the transferring portion based on the target length.

2. The battery cell manufacturing apparatus according to claim 1, wherein the target area is an area in which the exterior material and at least a part of the insulating portion overlap.

3. The battery cell manufacturing apparatus according to claim 2, wherein the controlling portion determines whether the preliminary assembly is disposed in a reference area positioned above the supporting portion based on the target length.

4. The battery cell manufacturing apparatus according to claim 3, wherein the reference area is positioned above the supporting portion.

5. The battery cell manufacturing apparatus according to claim 3, wherein when the target length is longer than or equal to a preset protrusion range or shorter than or equal to the protrusion range, the supporting portion moves to dispose the preliminary assembly in the reference area.

6. The battery cell manufacturing apparatus according to claim 5, wherein the transferring portion moves the preliminary assembly from the reference area to the target area.

7. The battery cell manufacturing apparatus according to claim 3, wherein when the target length is longer than or equal to a preset protrusion range or shorter than or equal to the protrusion range, the transferring portion moves the preliminary assembly deviated from the reference area to the target area.

8. The battery cell manufacturing apparatus according to claim 1, further comprising a guiding portion positioned between the photographing portion and the electrode lead to support the electrode lead.

9. The battery cell manufacturing apparatus according to claim 8, wherein the guiding portion is positioned to be spaced apart from electrode lead below the electrode load.

10. The battery cell manufacturing apparatus according to claim 8, wherein a length of the electrode lead along a protruding direction of the electrode lead is longer than or equal to a length from one surface of the guiding portion towards the electrode assembly to the electrode assembly.

11. The battery cell manufacturing apparatus according to claim 10, wherein the target length is a length from one surface of the guiding portion to one surface of the insulating portion provided to face each other.

12. The battery cell manufacturing apparatus according to claim 1, wherein the transferring portion is capable of transferring the preliminary assembly along an arbitrary direction.

13. A battery cell manufacturing method assembling a battery cell including: an electrode assembly; an exterior material accommodating the electrode assembly therein; an electrode lead electrically connected to the electrode assembly and protruding to the outside of the exterior material; and an insulating portion insulating between the exterior material and the electrode lead, comprising:
a step of disposing a preliminary assembly on a supporting portion capable of supporting the preliminary assembly in which the electrode assembly, the electrode lead, and the insulating portion are coupled;
a step of photographing a photographing area including the electrode lead and the insulating portion in the preliminary assembly; and
a transferring step of calculating a target length including the electrode lead and at least a part of the insulating portion along one preset direction in the photographing area and allowing a transferring portion to transfer the preliminary assembly to the target area based on the target length.

14. The battery cell manufacturing method according to claim 13, wherein the transferring step determines whether the preliminary assembly is disposed in a reference area based on the target length.

15. The battery cell manufacturing method according to claim 14, wherein whether the preliminary assembly is disposed in the reference area is determined by comparing the target length and a preset protrusion range.

16. The battery cell manufacturing method according to claim 15, wherein the target length is a length from one surface of the guiding portion to one surface of the insulating portion positioned between the electrode lead and the photographing portion to support the electrode lead.

17. The battery cell manufacturing method according to claim 15, wherein the transferring step includes:
a supporting portion adjustment step of allowing the supporting portion to move the preliminary assembly to the reference area; and
a positioning step of allowing the transferring portion to move the preliminary assembly from the reference area to the target area.

18. The battery cell manufacturing method according to claim 17, wherein the transferring step further includes a readjustment step of confirming whether the supporting portion disposes the preliminary assembly in the reference area and when the supporting portion does not disposed the preliminary assembly in the reference area, the supporting portion disposes the preliminary assembly in the reference area.

19. The battery cell manufacturing method according to claim 17, wherein in the supporting portion adjustment step, the supporting portion moves in parallel with a direction in which the electrode lead protrudes.

20. The battery cell manufacturing method according to claim 15, wherein in the transferring step, the transferring portion transfers a preliminary assembly deviated from the reference area to the target area.
